(19) United States
(12) Patent Application Publication
(10) Pub. No.: US 2004/0067665 A1
(43) Pub. Date: Apr. 8, 2004

(54) Socket connector and contact for use in a socket connector

(76) Inventor: Tomohiro Nakano, Kanagawa (JP)

Correspondence Address: Robert J Zeitler, Molex Incorporated, 2222 Wellington Court, Lisle, IL, 60532, US

(21) Appl. No.: 10/467,501

(22) PCT Filed: May 23, 2002
(86) PCT No.: PCT/US02/16389

(30) Foreign Application Priority Data
May 31, 2001 (JP) 2001-164404

(51) Int. Cl. H01R 12/00

(52) U.S. Cl. 439/70

(57) ABSTRACT

A socket connector and a contact for use in a socket connector is disclosed. The socket connector includes a plurality of contacts arranged in a grid shape and a socket body provided with the respective contacts. The contact includes a first contact piece and a second contact piece out of contact with each other in a first condition and in contact with each other in a second condition. When the first and second contact piece are in conctact with each other, the electric path length is shortened to reduce a self-inductance, thereby allowing the socket connector of the present invention to be used in high frequency application and in test and evaluation sockets.

### FIELD OF THE INVENTION

The present invention relates to a socket connector and a contact for use in a socket connector, and more particularly, a socket connector for use in high frequency applications and in test and evaluation sockets.

### BACKGROUND OF THE INVENTION

A socket for a semiconductor package with a plurality of solder balls arranged in a grid shape has been conventionally known in, for example, Japanese Patent Application Laid-open No. Hei 8-222335. As shown in FIGS. 13 to 15, the socket 300 disclosed in the publication is provided with a contact 305 provided with a substantially U-shaped cross-sectional base 302 formed by punching out of a metal plate and having side walls 301 on both sides, a substantially C-shaped elastic contact piece 303 extending from the lower portion of the base 302 to the side wall 301 side, extending upwardly of the base 302 and having a contact portion 303a contacting in the vicinity of the tip end with a solder ball S owned by an IC package 400, and a contact portion 304 extending from the lower end portion of the base 302 to the opposite side to the contact piece 303.

However, in the above-described conventional socket, in order that the solder ball S is in pressure contact with the contact portion 303a, the contact piece 303 is formed as an arcuate leaf spring. For this reason, it is difficult to shorten an electric path length from the contact portion 303a to the contact portion 304, it is impossible to reduce a self-inductance and it is impossible to test or evaluate the semiconductor package in a high frequency range. A socket, of the type shown in FIG. 16, provided at its upper and lower ends with contact portions and provided with a contact having a spring therebetween suffers from the same problems as described above.

### SUMMARY OF THE INVENTION

An object of the present invention is to provide a socket capable of performing a test or an evaluation of a semiconductor package in a high frequency range.

Another object of the present invention is to provide a socket connector for using in a high frequency range.

Another object of the present invention is to provide a socket in which the electric path length is shortened to reduce a self-inductance to thereby make it possible to perform a test or an evaluation of a semiconductor package (such as an IC package) in a high frequency range, and a contact for being mounted on the socket.

In one embodiment of the present invention, the novel contact is used in a test evaluation socket for a semiconductor package, although the contact is not limited solely to test socket applications. Rather, the novel contact may be used in any application where shortened electric path length is desired.

In one embodiment, the contact includes an arcuate leaf spring portion, a fixture portion for fixing said leaf spring portion to said socket connector, a contact portion provided at one end of said leaf spring portion, a conductive pattern contact portion provided at the other end of said leaf spring portion, a first contact piece provided at one end of said leaf spring, extending toward the other end of said leaf spring portion, and shiftable relative to said fixture portion, and a second contact piece provided at the other end of said leaf spring portion, extending toward one end of said leaf spring portion, and shiftable relative to said fixture portion.

The first contact piece and said second contact piece are set so as to be out of contact with each other in a first condition and in contact with each other in a second position.

The contact may contact with either a solder ball or a pin contact from the device being placed in contact with the contact.

The first contact piece and said second contact piece may be set so as to form an electric path length substantially in a linear form under the condition that said first contact piece and said second contact piece are in contact with each other.

Other objects, features and advantages of the invention will be apparent from the following detailed description taken in connection with the accompanying drawings.

### BRIEF DESCRIPTION OF THE ACCOMPANYING DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a plan view showing a test evaluation socket in accordance with an embodiment of the present invention.

FIG. 2 is a cross-sectional view showing a condition that the semiconductor package is mounted on the substrate connector in accordance with the embodiment of the present invention.

FIG. 3 is a perspective view of a contact provided in the test evaluation socket in accordance with the embodiment of the present invention.

FIG. 4 is a perspective view of the contact provided in the test evaluation socket in accordance with the embodiment of the present invention.

FIG. 5 is a partially enlarged view of an A-A sectional view shown in FIG. 1.

FIG. 6 is a partially enlarged view of a B-B sectional view of the test evaluation socket shown in FIG. 1.

FIG. 7 is a partially enlarged view of a bottom surface 14 shown in FIG. 1.

FIG. 8 is a plan view showing a test evaluation socket in accordance with another embodiment of the present invention.

FIG. 9 is a cross-sectional view of the test evaluation socket shown in FIG. 8.

FIG. 10 is a cross-sectional view of the test evaluation socket shown in FIG. 8.

FIG. 11 is a cross-sectional view of the test evaluation socket shown in FIG. 8.

FIG. 12 is a cross-sectional view of the test evaluation socket shown in FIG. 8.

FIG. 13 is a view illustrative of a conventional socket.

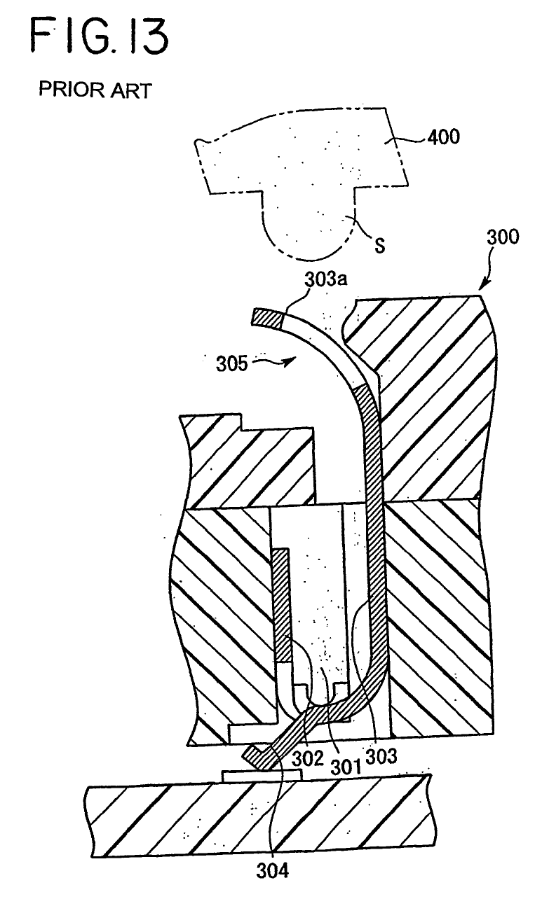

FIG. 14 is a frontal view of a contact provided in the conventional socket.

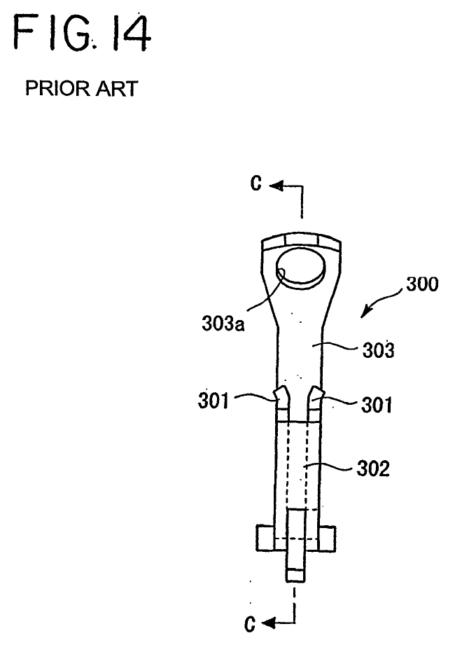

FIG. 15 is a side view of the contact provided in the conventional socket.

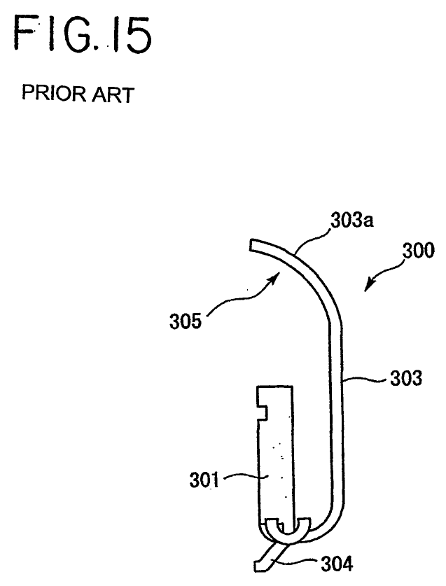

FIG. 16 is a view illustrative of the contact provided in the conventional socket.

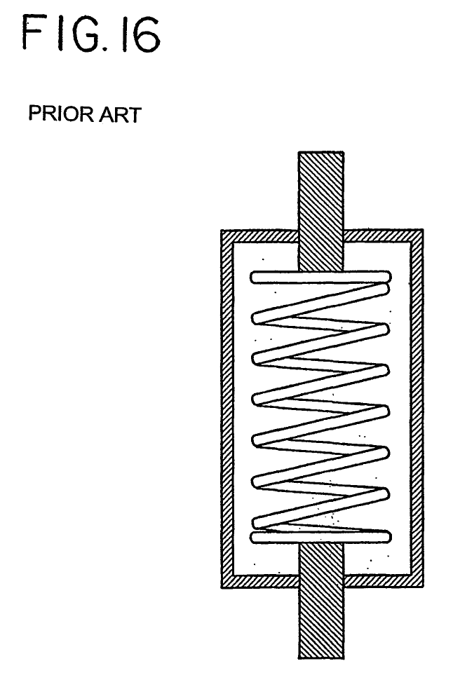

### DESCRIPTION OF THE PREFERRED EMBODIMENTS

A test evaluation socket for a semiconductor package in accordance with an embodiment of the present invention will now be described with reference to the accompanying drawings.

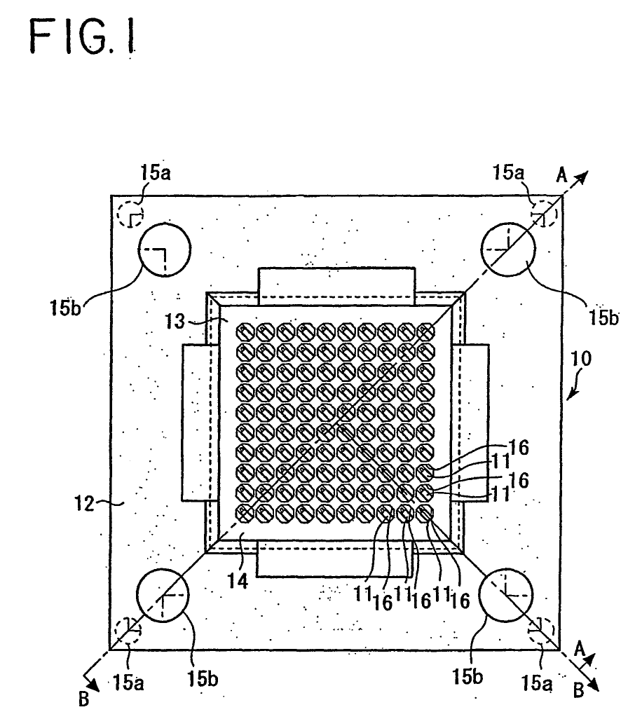

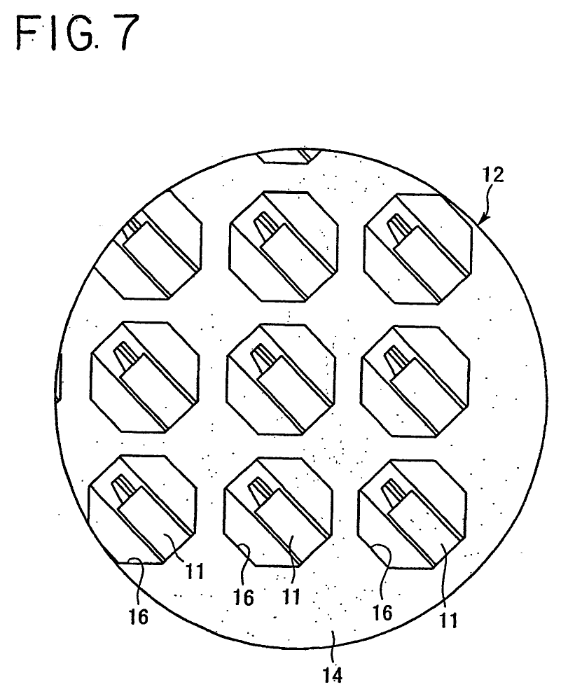

As shown in FIGS. 1, 2 and 7, the test evaluation socket 10 is a BGA (Ball Grid Array) test evaluation socket for a semiconductor package 50 having on its bottom surface a plurality of solder balls S arranged in a grid shape. The test evaluation socket 10 is provided with a plurality of contacts 11, arranged in a grid shape corresponding to the arrangement of the solder balls S and a socket body 12 provided with the respective contacts 11.

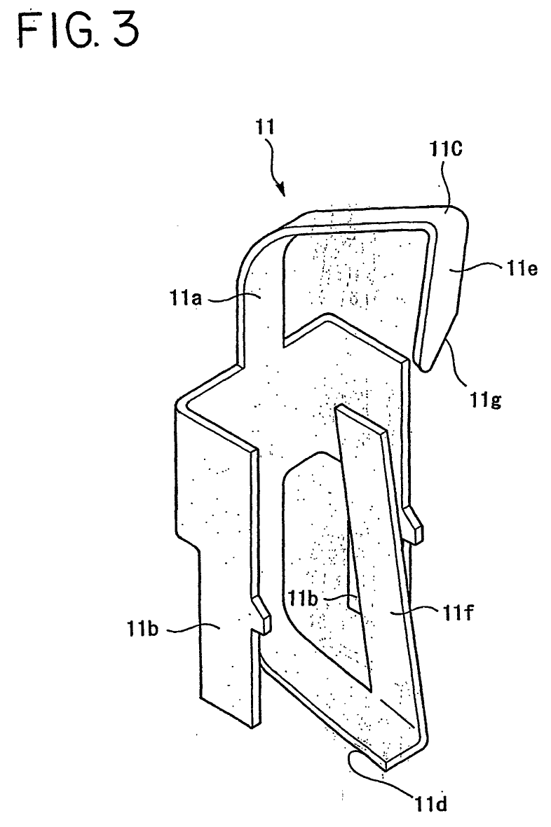

As shown in FIGS. 3, 5 and 6, each contact 11 is formed by bending a conductive metal plate. Each contact 11 is provided with an arcuate leaf spring portion 11a, a fixture portion 11b press fitted in a contact receiving hole 16 formed in the socket body 12 for fixing a substantially middle portion of the leaf spring portion 11a, a solder ball contact portion 11c provided outside one end of the leaf spring portion 11a and in pressing contact with the solder ball S, a conductive pattern contact portion 11d provided outside the other end of the leaf spring portion 11a and in pressing contact with a conductive pattern (not shown) of a substrate B, an upper contact piece 11e as a first contact piece provided at one end of the leaf spring portion 11a, extending in a linear manner toward the other end of the leaf spring portion 11a, and shiftable relative to the fixture portion 11b, and a cantilever type lower contact piece 11f as a second contact piece provided at a side surface of the other end of the leaf spring portion 11a, extending in a linear manner toward one end of the leaf spring portion 11a, and shiftable relative to the fixture portion 11b.

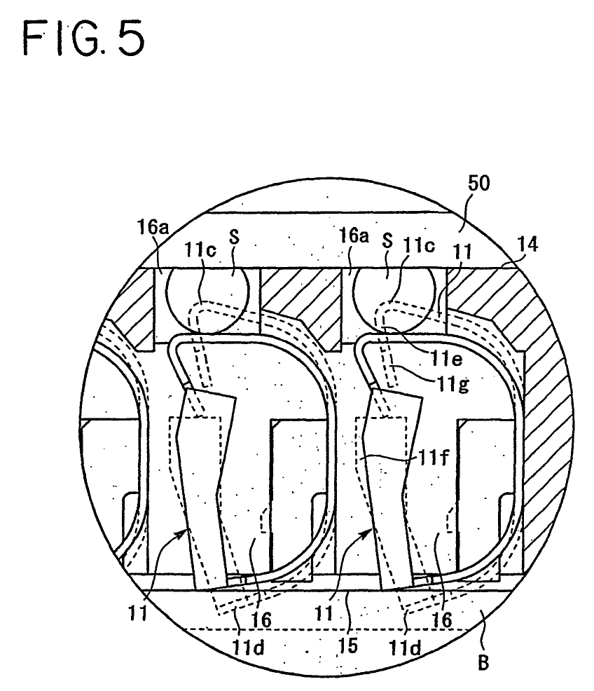

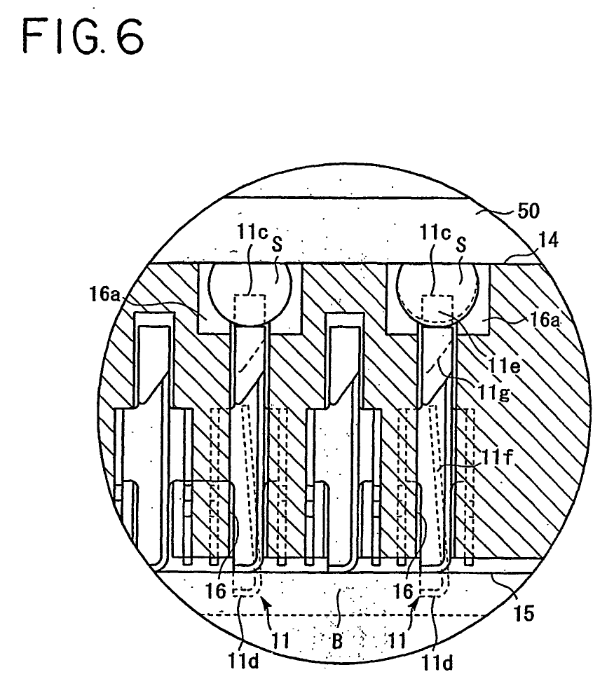

Each length of the upper contact piece 11e and the lower contact piece 11f and each bending angle thereof to the leaf spring portion 11a are set such that the contact pieces are not brought into contact with each other under the condition that the solder ball S is not in contact with the solder ball contact portion 11c and the conductive pattern of the substrate B is not in contact with the conductive pattern contact portion 11d (see the contact 11 indicated by dotted lines in FIGS. 5 and 6).

Also, each length of the upper contact piece 11e and the lower contact piece 11f and each bending angle thereof to the leaf spring portion 11a are set such that the contact pieces are brought into contact with each other under the condition that the solder ball S is in pressing contact with the solder ball contact portion 11c, the conductive pattern of the substrate B is in pressing contact with the conductive pattern contact portion 11f and both the upper contact piece and the lower contact piece are shifted in a direction close to each other (see the contact 11 indicated by solid lines in FIGS. 5 and 6).

A slant surface 11g with which the lower contact piece 11f contacts is provided on the side surface of the upper contact piece 11e. With respect to the slant surface 11g, the tip end of the lower contact piece 11f is brought into linear contact with the slant surface 11g and moved relative thereto and along therewith in the process that the solder ball S comes into pressing contact with the solder ball contact portion 11c and the conductive pattern of the substrate B comes into pressing contact with the conductive pattern contact portion 11d so that the upper contact piece 11e and the lower contact piece 11f are shifted in the direction close to each other. The contact 11 indicated by the dotted lines in FIGS. 5 and 6 represents a position before the shift and the contact 11 indicated by the solid lines represents a position after the shift.

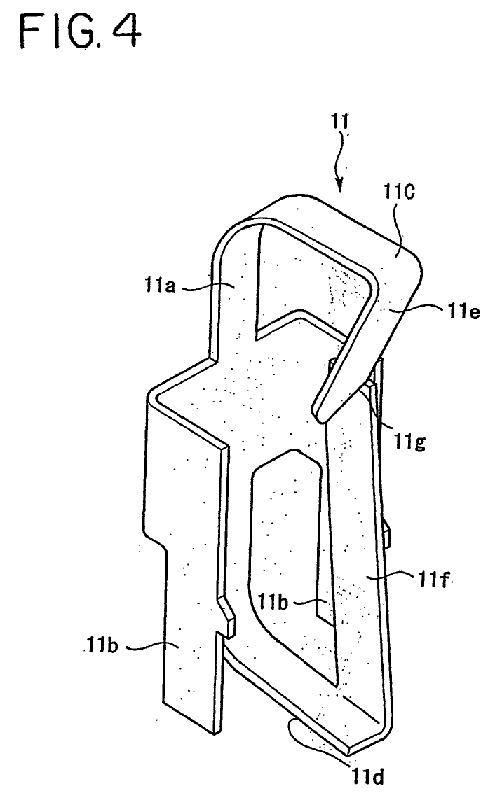

The upper contact piece 11e and the lower contact piece 11f are set in a linear condition so as to form the electrical path length substantially in the linear manner under the condition that they are brought into contact with each other (see FIGS. 4, 5 and 6).

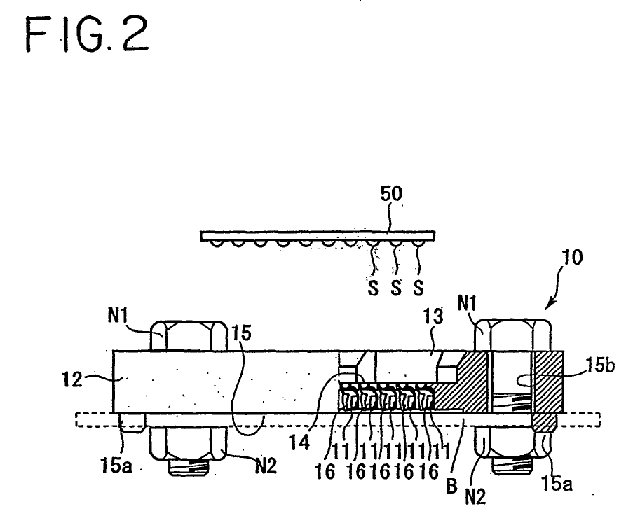

As shown in FIGS. 1 and 2, a socket body 12 is formed into a box-shape having a substantially rectangular form in plane and is provided with an opening 13 into which the semiconductor package 50 is to be inserted, and a plurality of contact receiving holes 16, extending from the semiconductor package carrier surface 14 to a substrate facing surface 15. Also, bosses 15a that are to be inserted into boss holes (not shown) formed in the substrate B are provided in the substrate facing surface 15.

Each contact receiving hole 16 is arranged in the grid shape corresponding to the arrangement of the solder balls S. As shown in FIGS. 5 and 6, solder ball receiving spaces 16a are located on the upper side of each contact receiving hole 16.

Each contact 11 is received in the associated receiving hole 16 with its solder ball contact portion 11c located in the solder ball receiving space 16a and its conductive pattern contact portion 11d projecting from the substrate facing surface 15 (i.e., the condition indicated by the dotted lines of FIGS. 5 and 6).

The operation of the test evaluation socket 10 for the semiconductor package with the above-described structure will now be described with reference to the drawings.

First of all, the bosses 15a provided, respectively, at four corners of the bottom surface of the socket body 12 are inserted into the boss holes formed in the substrate B. Then, the socket body 12 and the substrate B are fixed to each other by means of the screw fastening holes 15b and screws N1 inserted in the screw holes formed in the substrate B and nuts N2. Under this condition, the conductive pattern contact portion 11d projecting from the substrate facing surface 15 of the socket body 12 is in pressing contact with the conductive pattern of the substrate B. Thus, the lower contact piece 11f is shifted in the direction close to the upper contact piece 11e.

Subsequently, the semiconductor package 50 is inserted into the opening 13 of the socket body 12 and pressed against the semiconductor package carrier surface 14. Since the solder ball contact portion 11c of the contact 11 is located in the solder ball receiving space 16a, when the semiconductor package 50 is depressed against the semiconductor package carrier surface, the solder ball S is brought into pressing contact with the solder ball contact portion 11e and the upper contact piece 11e is shifted in the direction close to the lower contact piece 11f. The amount of shift thereof is limited by the contact of the lower surface (solder ball arrangement surface) of the semiconductor package 50 with the semiconductor package carrier surface 14.

Since the slant surface 11g with which the lower contact piece 11f contacts is provided on the side surface of the upper contact piece 11e, under the process that the upper contact piece 11e and the lower contact piece 11f are shifted in the direction close to each other as described above, the slant surface 11g is brought into linear contact with the tip end of the lower contact piece 11f which is relatively moved to the slant surface 11g. Accordingly, since the respective amounts of shift in the upper and lower directions of the upper contact piece 11e and the lower contact piece 11f may be increased, it is possible to obtain the sufficient pressing contact by the action of the leaf spring portion 11a. The contact 11 shown by the dotted lines in FIG. 5 represents the position before the shift and the contact 11 indicated by the solid lines in FIG. 6 represents the position after the shift.

Also, since the upper contact piece 11e and the lower contact piece 11f both extend in the linear manner, a new, substantially linear shortest electrical path length may be formed under the condition that the contact pieces are brought into linear contact with each other (see FIGS. 4, 5 and 6). Accordingly, it is possible to reduce the electrical path length to reduce the self-inductance, whereby it becomes possible to perform the test or the evaluation of the semiconductor package 50 in the high frequency range. Also, since the upper contact piece 11e and the lower contact piece 11f are brought into linear contact with each other, it is possible to ensure further stabilized and excellent contact.

The semiconductor package 50 may be depressed against the semiconductor package carrier surface 14 by the well known mechanical device or by the manual work by the worker. Incidentally, the socket 10 and the contact 11 may also be used as PGA (Pin Grid Array) socket.

A test evaluation socket for a semiconductor package in accordance with another embodiment of the present invention will now be described with reference to the drawings. Incidentally, the contact applied to the present socket is the same as that described above, the same reference numerals are used for explanation.

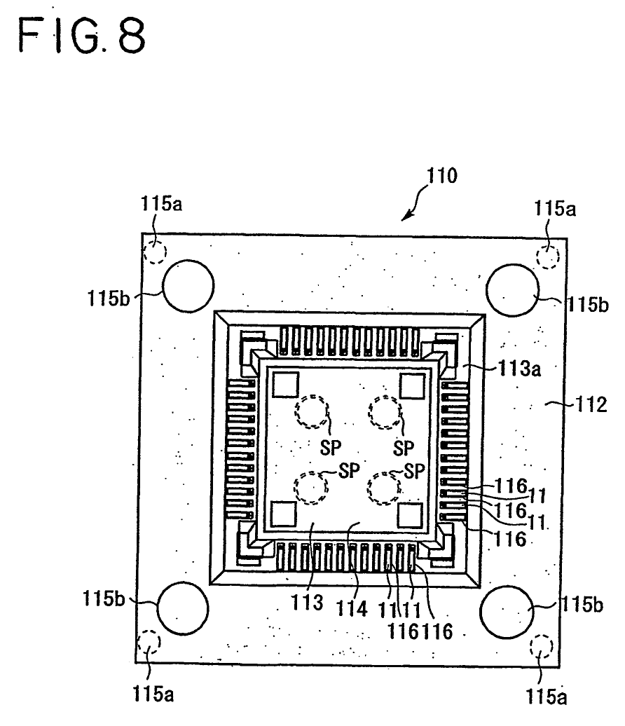

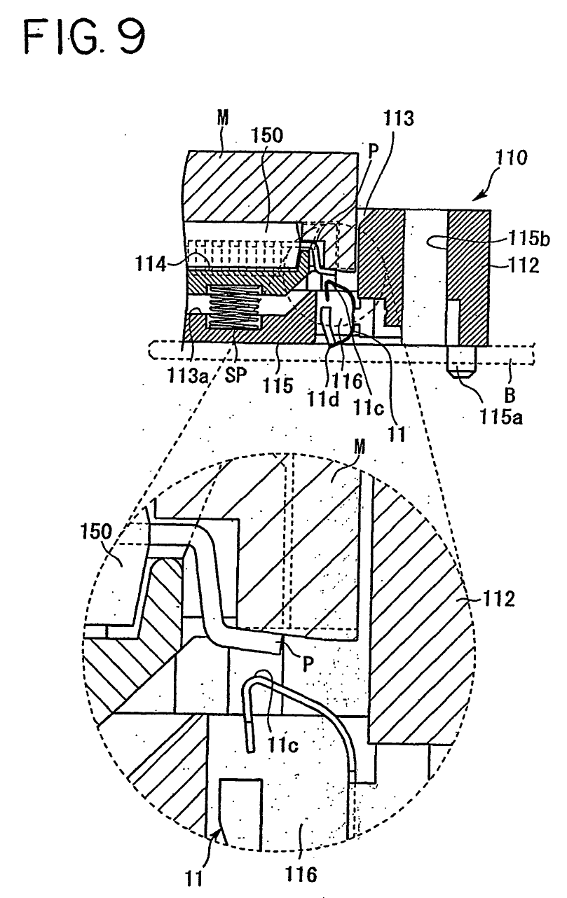

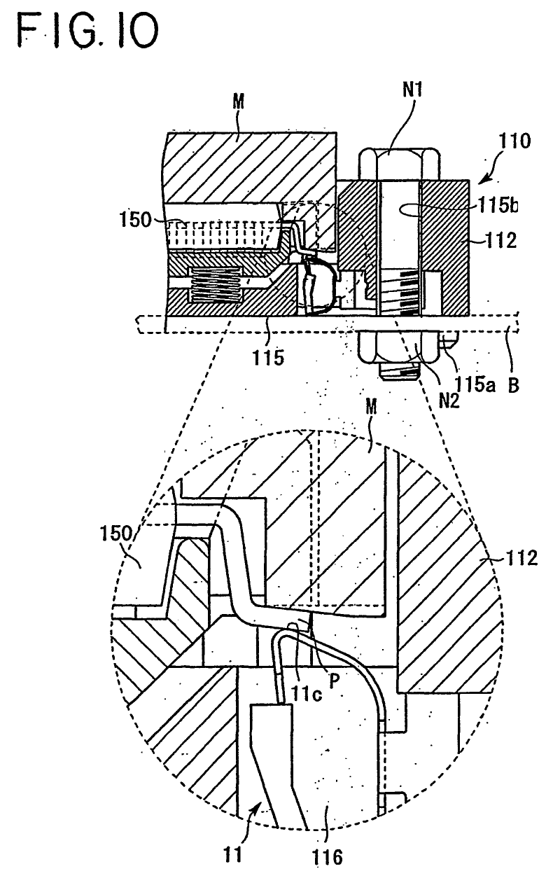

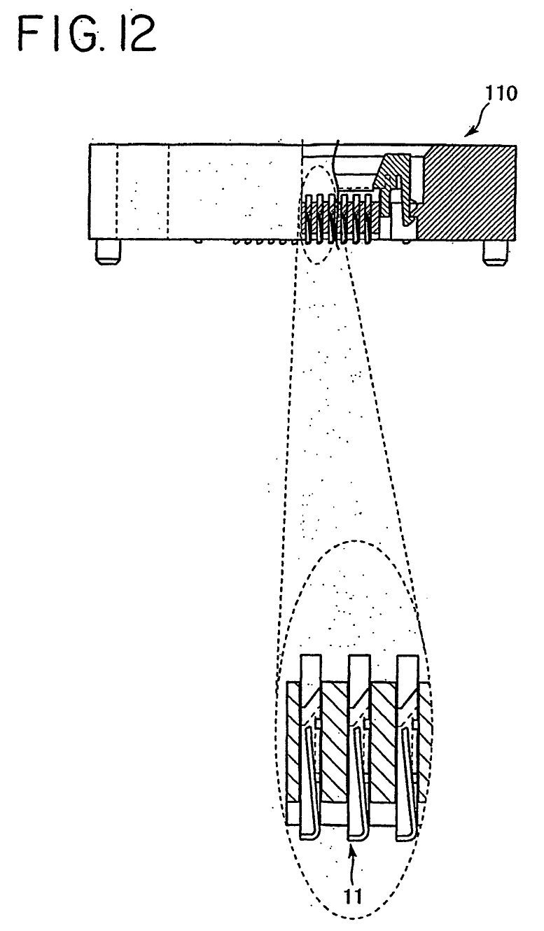

FIG. 8 is a plan view of the test evaluation socket in accordance with the other embodiment of the present invention. FIGS. 9 to 12 are cross-sectional views of the test evaluation socket shown in FIG. 8.

As shown in FIGS. 8 and 9, the test evaluation socket 110 is a test evaluation socket for a semiconductor package 150 having around its outer circumference a plurality of pin terminals P. The test evaluation socket 110 is provided with a plurality of contacts 11, arranged correspondingly to the arrangement of the pin terminals P and a socket body 112 provided with the respective contacts 11.

As shown in FIGS. 3, 9 and 12, each contact 11 is formed by means of a bending work of a conductive metal plate. Each contact 11 is provided with an arcuate leaf spring portion 11a, a fixture portion 11b press fitted in a contact receiving hole 116 formed in the socket body 112 for fixing a substantially middle portion of the leaf spring portion 11a, a pin terminal contact portion 11c provided outside one end of the leaf spring portion 11a and in pressing contact with the pin terminal P, a conductive pattern contact portion 11d provided outside the other end of the leaf spring portion 11a and in pressing contact with a conductive pattern (not shown) of the substrate B, an upper contact piece 11e as a first contact piece provided at one end of the leaf spring portion 11a, extending in a linear manner toward the other end of the leaf spring portion 11a, and shiftable relative to the fixture portion 11b, and a cantilever type lower contact piece 11f as a second contact piece provided at a side surface of the other end of the leaf spring portion 11a, extending in a linear manner toward one end of the leaf spring portion 11a and shiftable relative to the fixture portion 11b.

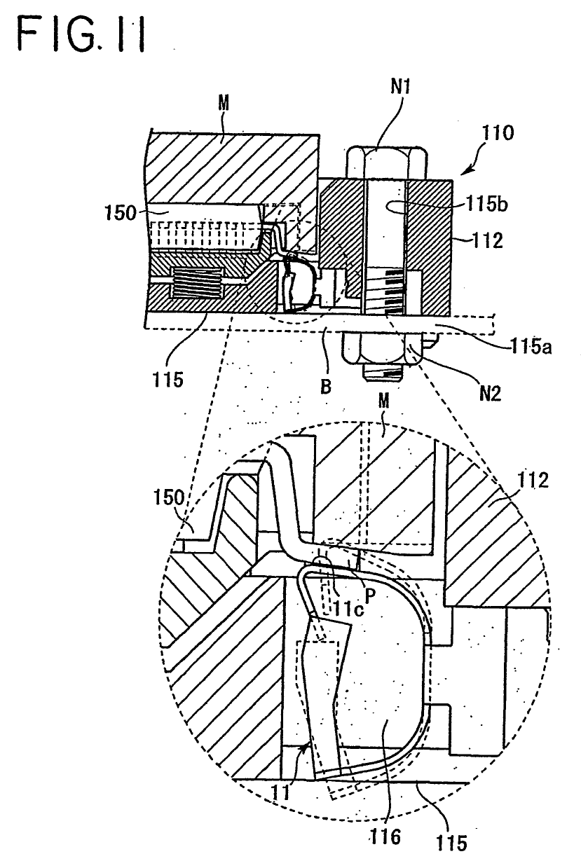

Each length of the upper contact piece 11e and the lower contact piece 11f and each bending angle thereof to the leaf spring portion 11a are set such that the contact pieces are not brought into contact with each other under the condition that the pin terminal P is not in contact with the pin terminal contact portion 11c and the conductive pattern of the substrate B is not in contact with the conductive pattern contact portion 11d (see the contact 11 as indicated by dotted lines in FIGS. 3 and 11).

Also, each length of the upper contact piece 11e and the lower contact piece 11f and each bending angle thereof to the leaf spring portion 11a are set such that the contact pieces are brought into contact with each other under the condition that the pin terminal P is in pressing contact with the pin terminal contact portion 11c, the conductive pattern of the substrate B is in pressing contact with the conductive pattern contact portion 11f, and both the upper contact piece and the lower contact piece are shifted in a direction close to each other (see the contact 11 indicated by solid lines in FIG. 11).

A slant surface 11g with which the lower contact piece 11f contacts is provided on the side surface of the upper contact piece 11e. With respect to the slant surface 11g, the tip end of the lower contact piece 11f brought into linear contact with the slant surface 11g and moved relative thereto and along therewith in the process that the pin terminal P comes into pressing contact with the pin terminal contact portion 11c and the conductive pattern of the substrate B comes into pressing contact with the conductive pattern contact portion 11d so that the upper contact piece 11e and the lower contact piece 11f are shifted in the direction close to each other (see FIGS. 9, 10 and 11). The contact 11 indicated by the dotted line in FIG. 11 represents a position before the shift and the contact 11 indicated by the solid line represents a position after the shift.

The upper contact piece 11e and the lower contact piece 11f are set in a linear condition so as to form the electrical path length substantially in the linear manner under the condition that they are brought into contact with each other (see FIGS. 4, 11 and 12).

As shown in FIG. 8, a socket body 112 is formed into a box-shape having a substantially rectangular form in plane and is provided with an opening 113 into which the semiconductor package 150 is to be inserted. The semiconductor package 150 includes a semiconductor package carrier plate 114 mounted on a bottom surface 113a of the opening 113 of the socket body 112 through springs SP and is reciprocatingly movable between a first position (upper end position) and a second position (lower end position) within the opening 113.

The upper end position is a position where the semiconductor package 150 is laid on the semiconductor package carrier plate 114 with its pin terminals P projected from a circumferential edge of the semiconductor package carrier plate 114 (see FIG. 9). The lower end position is a position where the projected pin terminals P comes into pressing contact with the pin terminal contact portions 11c (see FIG. 11).

Also, the socket body 112 is provided with a substrate facing surface 115 opposite to the bottom surface 113a and a plurality of contact receiving holes 116, bored through from the bottom surface 113a to the substrate facing surface 115. Also, bosses 115a to be inserted into the boss holes (not shown) formed in the substrate B are provided in the substrate facing surface 115.

Each contact receiving hole 16 is arranged correspondingly to the arrangement of the pin terminals P. Each contact 11 is received in the associated contact receiving hole 116 with its pin terminal contact portion 11c projected from the bottom surface 113 and its conductive pattern contact portion 11d projected from the substrate facing surface 115 (i.e., the condition indicated by dotted line of FIG. 11).

The operation of the test evaluation socket 110 for the semiconductor package with the above-described structure will now be described with reference to the drawings.

First of all, the bosses 115a provided, respectively, at four corners of the bottom surface of the socket body 112 are inserted into the boss holes formed in the substrate B. Then, the socket body 112 and the substrate B are fixed to each other by means of the screw fastening holes 115b and screws N1 inserted in the screw holes formed in the substrate B and nuts N2. Under this condition, the conductive pattern contact portion 11d projecting from the substrate facing surface 115 of the socket body 112 is brought into pressing contact with the conductive pattern of the substrate B. Thus, the lower contact piece 11f is shifted in the direction close to the upper contact piece 11e.

Subsequently, the semiconductor package 150 is inserted into the opening 113 of the socket body 112 and pressed against the semiconductor package carrier plate 114. Since the semiconductor package carrier plate 114 is mounted on the bottom surface 113a of the opening 113 of the socket body 112 through the springs SP, when the semiconductor package 150 is depressed against the semiconductor package carrier plate 114, the pin terminal contact portion 11e is brought into pressing contact with the pin terminal contact portion 11c and the upper contact piece 11e is shifted in the direction close to the lower contact piece 11f. The amount of shift thereof is limited by the contact of the lower surface of the semiconductor package carrier plate 114 with the bottom surface 113a of the opening 113.

Since the slant surface 11g with which the lower contact piece 11f contacts is provided on the side surface of the upper contact piece 11e, under the process that the upper contact piece 11e and the lower contact piece 111f are shifted in the direction close to each other as described above, the slant surface 11g is brought into linear contact with the tip end of the lower contact piece 11f which is relatively moved to the slant surface 11g. Accordingly, since the respective amounts of shift in the upper and lower directions of the upper contact piece 11e and the lower contact piece 11f may be increased, it is possible to obtain the sufficient pressing contact by the action of the leaf spring portion 11a. The contact 11 shown by the dotted line in FIG. 11 represents the position before the shift and the contact 11 indicated by the solid line represents the position after the shift.

Also, since the upper contact piece 11e the lower contact piece 11f both extend in the linear manner, a new, substantially linear shortest electrical path length may be formed under the condition that the contact pieces are brought into contact with each other (FIGS. 4, 11 and 12). Accordingly, it is possible to reduce the electrical path length to reduce the self-inductance, whereby it becomes possible to perform the test or the evaluation of the semiconductor package 50 in the high frequency range. Also, since the upper contact piece 11e and the lower contact piece 11f are brought into linear contact with each other, it is possible to ensure further stabilized and excellent contact.

The semiconductor package 150 may be gripped by the well known mechanical device M or depressed against the semiconductor package carrier surface 14 by the manual work by the worker.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

1. A test evaluation socket for a semiconductor package having a plurality of conductive elements, the test evaluation socket comprising:
a plurality of contacts and a socket body provided with the respective contacts,
wherein each contact includes an arcuate leaf spring portion, a fixture portion for fixing said leaf spring portion to said socket body, a conductive element contact portion provided at one end of said leaf spring portion, a conductive pattern contact portion provided at the other end of said leaf spring portion, a first contact piece provided at one end of said leaf spring portion, extending toward the other end of said leaf spring portion, and shiftable relative to said fixture portion, and a cantilever type second contact piece provided at the other end of said leaf spring portion, extending toward one end of said leaf spring portion, and shiftable relative to said fixture portion, and
wherein said first contact piece and said second contact piece are set so as to be out of contact with each other under the condition that the conductive element is out of contact with said conductive element contact portion and the conductive pattern of the substrate is out of contact with said conductive pattern contact portion, and so as to be in contact with each other under the condition that the conductive element is in pressing contact with said conductive element contact portion, the conductive pattern of the substrate is in pressing contact with said conductive pattern contact portion and said first contact piece and said second contact piece are shifted in a direction close to each other.

2. The test evaluation socket for a semiconductor package according to claim 1, wherein a slant surface with which said second contact piece contacts is formed in said first contact piece, and
wherein said second contact piece is brought into contact with said slant surface add moved relative to said slant surface in the process that said conductive element comes into pressing contact with said conductive element contact portion and said conductive pattern of the substrate comes into pressing contact with said conductive pattern contact portion so that said first contact piece and said second contact piece are shifted in the direction close to each other.

3. The test evaluation socket for a semiconductor package according to Claim 1, wherein said first contact piece and said second contact piece are set so as to form an electrical path length substantially in a linear form under the condition that said first contact piece and said second contact piece are in contact with each other.

4. The test evaluation socket for a semiconductor package according to claim 1, wherein said socket body comprises a carrier surface of the semiconductor package, a substrate facing surface opposite thereto and a plurality of contact receiving holes bored through from the carrier surface of the semiconductor package to the substrate facing surface,
wherein each of said contact receiving holes is arranged in the grid shape,
wherein a conductive element receiving space in which each laid conductive element of the semiconductor package is located is provided on the side of the semiconductor package carrier surface of each contact receiving hole, and
wherein each contact is received in the associated contact receiving hole under the condition that the conductive element contact portion is located in said conductive element receiving space and the conductive pattern contact portion is projected from said substrate facing surface.

5. The test evaluation socket for a semiconductor package according to claim 1, wherein the conductive element is a solder ball.

6. The test evaluation socket for a semiconductor package according to claim 5, wherein a slant surface with which said second contact piece contacts is formed in said fit contact piece, and
wherein said second contact piece is brought into contact with said slant surface and moved relative to said slant surface in the process that said solder ball comes into pressing contact with said solder ball contact portion and said conductive pattern of the substrate comes into pressing contact with said conductive pattern contact portion so that said first contact piece and said second contact piece are shifted in the direction close to each other.

7. The test evaluation socket for a semiconductor package according to claim 5, wherein said first contact piece and said second, contact piece are set so as to form an electrical path length substantially in a linear form under the condition that said first contact piece and said second contact piece are in contact with each other.

8. The test evaluation socket for a semiconductor package according to claim 5, wherein said socket body comprises a crier surface of the semiconductor package, a substrate facing surface opposite thereto and a plurality of contact receiving holes bored through from the carrier surface of the semiconductor package to the substrate facing surface,
wherein each of said contact receiving holes is arranged in the grid shape,
wherein a solder ball receiving space in which each laid solder ball of the semiconductor package is located is provided on the side of the semiconductor package carrier surface of each contact receiving hole, and
wherein each contact is received in the associated contact receiving hole under the condition that the solder ball contact portion is located in said solder ball receiving space and the conductive pattern contact portion is projected from said substrate facing surface.

9. The test evaluation socket for a semiconductor package according to claim 1, wherein the conductive element is a pin terminal.

10. The test evaluation socket for a semiconductor package according to claim 9, wherein a slant surface with which said second contact piece contacts is formed in said first contact piece, and
wherein said second contact piece is brought into contact with said slant surface and moved relative to said slant surface in the process that said pin terminal comes into pressing contact with said pin terminal contact portion and said conductive pattern of the substrate comes into pressing contact with said conductive pattern contact portion so that said first contact piece and said second contact piece are shifted in the direction close to each other.

11. The test evaluation socket for a semiconductor package according to claim 9, wherein said first contact piece and said second contact piece are set so as to form an electrical path length substantially in a linear form under the condition that said fist contact piece and said second contact piece are in contact with each other.

12. The test evaluation socket for a semiconductor package according to claim 9, wherein:
said socket body comprises a carrier plate of the semiconductor package;
said semiconductor package carrier plate is mounted on said socket body % through springs so as to be reciprocatingly movable between a first position and a second position;
said first position is a position where the semiconductor package is laid on said semiconductor package carrier plate with its pin terminals projected from a circumferential edge of the semiconductor package carrier plate; and
said second position is a position where the projected pin terminals are in pressing contact with said pin terminal contact portions.

13. The test evaluation socket for a semiconductor package according to claim 1, wherein the plurality of contacts are arranged in a grid pattern.

14. The test evaluation socket for a semiconductor package according to claim 1, wherein the plurality of contacts are arranged in an outer circumference.

15. A contact for use in a socket connector, the socket connector capable of receiving a semiconductor package having a contact body, the contact comprising:
an arcuate leaf sprig portion, a fixture portion for fixing said leaf spring portion to said socket connector, a contact portion provided at one end of said leaf spring portion, a conductive pattern contact portion provided at the other end of said leaf spring portion, a first contact piece provided at one end of said leaf spring, extending toward the other end of said leaf spring portion, and shiftable relative to said fixture portion, and a cantilever type second contact piece provided at the other end of said leaf spring portion, extending toward one end of said leaf spring portion, and shiftable relative to said fixture portion,
wherein said first contact piece and said second contact piece are set so as to be out of contact with each other under the condition that the contact body is out of contact with said contact portion and the conductive pattern of the substrate is out of contact with said conductive pattern contact portion, and so as to be in contact with each other under the condition that the contact body is in pressing contact with said contact portion, the conductive pattern of the substrate is in pressing contact with said conductive pattern contact portion, and said first contact piece and said second contact piece are shifted in a direction close to each other.

16. The contact according to claim 15, wherein said contact body is a solder ball.

17. The contact according to claim 15, wherein said contact body is a pin terminal.

18. The contact according to claim 15, wherein said first contact piece and said second contact piece are set so as to form an electric path length substantially in a linear form under the condition that said first contact piece and said second contact piece are in contact with each other.

19. A socket connector, comprising:
a plurality of contacts and a socket body provided with the respective contacts,
each contact including an arcuate leaf spring portion, a fixture portion for fixing said leaf spring portion to said socket connector, a contact portion provided at one end of said leaf spring portion, a conductive pattern contact portion provided at the other end of said leaf spring portion, a first contact piece provided at one end of said leaf spring, extending toward the other end of said leaf spring portion, and shiftable relative to said fixture portion, and a second contact piece provided at the other end of said leaf spring portion, extending toward one end of said leaf spring portion, and shiftable relative to said fixture portion,
wherein said first contact piece and said second contact piece are set so as to be out of contact with each other under the condition that the contact body is out of contact with said contact portion and the conductive pattern of the substrate is out of contact with said conductive pattern contact portion, and so as to be in contact with each other under the condition that the contact body is in pressing contact with said contact portion, the conductive pattern of the substrate is in pressing contact with said conductive pattern contact portion, and said first contact piece and said second contact piece are shifted in a direction close to each other.

20. The socket connector of claim 19, wherein the second contact piece is cantilevered.

21. The socket connector of claim 19, wherein said first contact piece and said second contact piece are set so as to form an electric path length substantially in a linear form under the condition that said first contact piece and said second contact piece are in contact with each other.

22. The socket connector of claim 19, wherein the contact piece includes a slant surface for contacting the second contact piece.

23. The socket connector of claim 22, wherein said second contact piece is brought into contact with said slant surface and moved relative to said slant spice in the process that said solder ball comes into pressing contact with said solder ball contact portion and said conductive pattern of the substrate comes into pressing contact with said conductive pattern contact portion so that said first contact piece and said second contact piece are shifted in the direction close to each other.
